(19) United States
(12) Patent Application Publication
(10) Pub. No.: US 2012/0213999 A1
(43) Pub. Date: Aug. 23, 2012

(54) GRAPHITE NANO-CARBON FIBER AND METHOD OF PRODUCING THE SAME

(75) Inventors: Katsuki IDE, Chigasaki-shi (JP); Tsuyoshi NOMA, Yokohama-shi (JP); Kazutaka KOJO, Yokohama-shi (JP); Tetsuya MINE, Chiba-shi (JP); Masao KON, Yokohama-shi (JP); Jun YOSHIKAWA, Chigasaki-shi (JP)

(73) Assignee: KABUSHIKI KAISHA TOSHIBA, Tokyo (JP)

(21) Appl. No.: 13/204,495

(22) Filed: Aug. 5, 2011

(30) Foreign Application Priority Data
Feb. 18, 2011 (JP) 2011-033723

(51) Int. Cl. D01F 9/12; B82Y 40/00; B82Y 30/00

(52) U.S. Cl. 428/401; 423/447.2; 423/447.1; 977/762; 977/896

(57) ABSTRACT

According to one embodiment, there is provided a graphite nano-carbon fiber provided by using an apparatus having a reactor capable of keeping a reducing atmosphere inside thereof, a metal substrate arranged as a catalyst in the reactor, a heater heating the metal substrate, a hydrocarbon source supplying hydrocarbon to the reactor, a scraper scraping carbon fibers produced on the metal substrate, a recovery container recovering the scraped carbon fibers, and an exhaust pump discharging exhaust gas from the reactor. The carbon fibers are linear carbon fibers with a diameter of 80 to 470 nm formed with layers of graphenes stacked in a longitudinal direction.

### CROSS-REFERENCE TO RELATED APPLICATIONS

This application is based upon and claims the benefit of priority from prior Japanese Patent Application No. 2011-033723, filed Feb. 18, 2011, the entire contents of which are incorporated herein by reference.

### FIELD

Embodiments described herein relate generally to a graphite nano-carbon fiber and a method of producing the same.

### BACKGROUND

It is known to use, as a carbon nanostructure material, fibrous nano-carbon produced generally by bringing gas containing carbon into contact with a selected catalyst metal at a temperature of about 500° C. to 1200° C. for a prescribed period of time.

Examples of methods of producing a carbon nanostructure material include an ark discharge method, laser vapor deposition method, and chemical vapor deposition method (CVD method).

In the arc discharge method, arc discharge is made to generate between positive and negative graphite electrodes to thereby vaporize graphite, and a carbon nanotube is generated in a carbon deposit condensed at the tip of the negative electrode.

The laser vapor deposition method involves steps of adding a graphite sample mixed with a metal catalyst in inert gas heated to a high temperature and irradiating the graphite sample with a laser beam to thereby produce a carbon nanostructure material.

Although a carbon nanostructure material having high crystallinity can generally be generated in the arc discharge method and laser vapor deposition method, the amount of carbon to be generated is small and it is therefore said that these methods are scarcely applied to mass-production.

The CVD method is typified by two methods including a vapor deposition substrate method in which a carbon nanostructure material layer is formed on a substrate disposed in a reaction furnace and a fluidized vapor phase method in which a catalyst metal and a carbon source are fluidized together in a high-temperature furnace to synthesize a carbon nanostructure material.

However, the vapor deposition substrate method has a difficulty in attaining mass-production because it is carried out by batch treatment. Also, the direct injection pyrolytic method is inferior in temperature uniformity and is regarded as difficult to produce a carbon nanostructure material having high crystallinity. Moreover, a method modified from the fluidized vapor phase method is known in which a fluidized layer is formed in a high-temperature furnace from a fluidizing material also functioning as a catalyst and carbon raw material is supplied to the furnace to produce a fibrous carbon nanostructure material. This method is, however, inferior in temperature uniformity in the furnace so that it is assumed that this method has a difficulty in generating a carbon nanostructure material having high crystallinity.

The importance of nanostructure materials and particularly, graphite carbon nano-fibers has sharply increased in many industrial applications and studies as to the applications of these nanostructure materials are being made. Examples of these applications include occlusion and absorption/desorption of hydrogen, occlusion and absorption/desorption of lithium, catalytic action, and absorption and occlusion of nitrogen oxides. However, these nanostructure materials still have poor industrial applicability at present. One of the reasons is that structurally uniform graphite carbon nano-fibers cannot be mass-produced.

In light of this, if graphite carbon nano-fibers superior in the high stabilities of, for example, dimension, shape, structure and purity can be mass-produced efficiently at low cost, nano-technological products making use of the characteristics of these graphite carbon nano-fibers can be supplied in a large amount at low cost.

### BRIEF DESCRIPTION OF THE DRAWINGS

FIG. 1 is a schematic view of an apparatus of producing a graphite nano-carbon fiber according to a first embodiment;

FIG. 2 is a schematic view of an apparatus of producing a graphite nano-carbon fiber according to a second embodiment;

FIG. 3 is an electron microphotograph of a fine carbon fiber according to an embodiment;

FIG. 4 is an electron microphotograph of a fine carbon fiber according to an embodiment;

FIG. 5A and FIG. 5B are electron microphotographs of a fine carbon fiber according to an embodiment;

FIG. 6A and FIG. 6B are electron microphotographs of a fine carbon fiber according to an embodiment;

FIGS. 7A, 7B, 7C, and 7D are views schematically illustrating the structure of fine carbon fibers according to an embodiment;

FIG. 8 is a characteristic diagram showing the relations between the temperature, and temperature difference, differentiation of the temperature difference or variation in the weight of a fine carbon fiber according to an embodiment; and

FIG. 9 is a characteristic view showing the relation between the Raman shift and Raman intensity of a fine carbon fiber according to an embodiment.

### DETAILED DESCRIPTION

In general, according to one embodiment, there is provided a graphite nano-carbon fiber provided by using an apparatus having a reactor capable of keeping a reducing atmosphere inside thereof, a metal substrate arranged as a catalyst in the reactor, a heater heating the metal substrate, a hydrocarbon source supplying hydrocarbon to the reactor, a scraper scraping carbon fibers produced on the metal substrate, a recovery container recovering the scraped carbon fibers, and an exhaust pump discharging exhaust gas from the reactor. The carbon fibers are linear carbon fibers with a diameter of 80 to 470 nm formed with layers of graphenes stacked in a longitudinal direction.

Hereinafter, apparatuses of producing graphite nano-carbon fibers according to embodiments will be described with reference to the drawings.

### First Embodiment

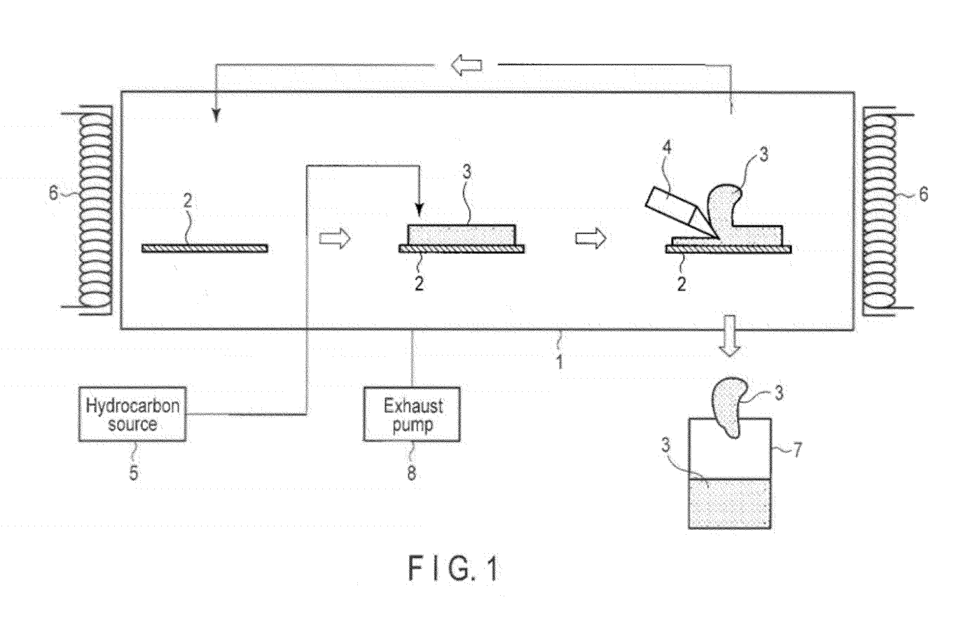

An apparatus of producing a graphite nano-carbon fiber according to a first embodiment will be described with reference to FIG. 1. A metal substrate (catalyst) 2 and a scraper 4 that scrapes fine carbon fibers 3 generated on the metal substrate 2 are arranged in the reactor 1 capable of keeping a reducing atmosphere inside thereof. A hydrocarbon source 5 that supplies hydrocarbon to the reactor 1 is connected to the reactor 1. A heater 6 that heats the metal substrate 2, a recovery container 7 that recovers the fine carbon fibers 3, and an exhaust pump 8 that discharges exhaust gas from the reactor 1 are arranged on the outside of the reactor 1.

Although ethanol is used as the hydrocarbon in the production apparatus of FIG. 1, ethylene, propane, methane, carbon monoxide, benzene or the like may be used as the hydrocarbon. As the metal substrate 2, an iron substrate which has the highest compatibility with an ethanol raw material is used. The metal substrate 2 may be a structural carbon steel plate or a stainless 304 steel plate containing iron components. Because an oxide film is ordinarily formed on the surface of the metal substrate which serves as a catalyst, the film is removed to activate the surface. As a method of activating the surface, the surface is polished and treated with an acid.

The followings describe the action of the production apparatus of FIG. 1.

First, the temperature of the reactor 1 is adjusted to 600° C. to 750° C. and preferably 670° C., and ethanol is preheated at 350° C. and injected into the reactor 1. Raw ethanol is thermally decomposed into gas in the reactor 1 and carbon atoms are incorporated into the metal substrate 2. Next, it is considered that when carbon on the metal substrate 2 is saturated, carbon precipitates on the metal substrate 2 and is grown into a crystal form. The matters grown into crystals are the fine carbon fibers 3.

Next, the fine carbon fibers 3 grown on the metal substrate 2 over several tens of minutes are scraped with the scraper 4 and recovered in the recovery container 7 outside of the reactor. In scraping, the fibers are scraped in such a manner that the fibers having a thickness of about 0 to 5 mm are left on the metal substrate 2 and then, the fine carbon fibers 3 grown again are scraped and these operations are repeated. Even if the fine carbon fibers left unscraped exist on the metal substrate 2, the amount of the fine carbon fibers to be generated can be kept constant for a long time because carbon is sufficiently supplied to the metal substrate 2.

### Second Embodiment

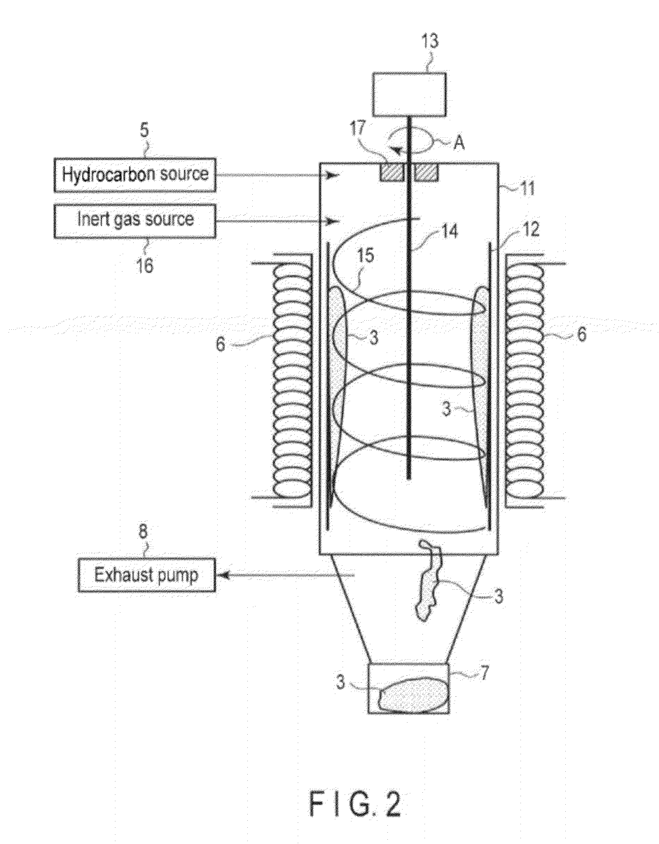

An apparatus of producing a graphite nano-carbon fiber according to a second embodiment will be described with reference to FIG. 2. In this case, the same members as those shown in FIG. 1 are designated by the same symbols and descriptions of these members are omitted.

A cylindrical metal substrate (catalyst) 12 is disposed inside of a vertical cylindrical reactor 11 which can shut off external air and keep a reducing atmosphere inside thereof, and is arranged coaxially with the reactor 11. In the reactor 11, a scraper that scrapes fine carbon fibers 3 generated on the surface of the metal substrate 12 is arranged. Here, the scraper is constituted by a driving unit 13, a main shaft 14 which is axially supported by the driving unit 13 in such a manner as to be rotatable in the direction of the arrow A, and a spiral scraping blade 15 attached to the main shaft 14. An inert gas source 16 is communicated with the reactor 11 to supply inert gas. A seal member 17 is arranged around the main shaft 14 on the upper part of the reactor 11. It should be noted that the hydrocarbon and metal substrate material used in the production apparatus of FIG. 2 are the same as those described in FIG. 1. In this case, however, the metal substrate 12 which serves as the catalyst is configured to be replaceable with a new one after a prescribed period of time, because it is reduced in wall thickness in the course of synthesis of carbon fibers.

The followings describe the action of the production apparatus of FIG. 2.

First, the temperature of the reactor 11 is adjusted to 600° C. to 750° C. and preferably 670° C., and ethanol is preheated at 350° C. and injected into the reactor 11. Raw ethanol is thermally decomposed into gas in the reactor 11 and carbon atoms are incorporated into the metal substrate 12. Next, it is considered that when carbon on the metal substrate 12 is saturated, carbon precipitates on the metal substrate 12 and is grown into a crystal form. The matters grown into crystals are the fine carbon fibers 3.

Next, the fine carbon fibers 3 grown on the metal substrate 2 over several tens of minutes are scraped with the scraper 4 and recovered in the recovery container 7 outside of the reactor. In scraping, the distance between the metal substrate 12 and the tips of rotary blade 15 is adjusted in such a manner that the fibers having a thickness of about 0 to 5 mm are left on the metal substrate 12. Here, the scraping blade 15 having a spiral form is rotated at a rate of 0.01 to 0.05 rpm in the direction of the arrow A by the driving unit 13 to scrape fibers continuously or intermittently at intervals of 20 to 60 min. As a result, the fine carbon fibers 3 are scraped, and then, the fine carbon fibers 3 grown again are scraped again, thereby enabling continuous production. Even if the fine carbon fibers left unscraped exist, the amount of the fine carbon fibers to be generated can be kept constant for a long time because carbon is sufficiently supplied to the metal substrate.

The above descriptions are relating to the apparatus and method of producing fine carbon fibers, and then, the followings describe the dimension, shape, structure and purity of the generated fine carbon fibers.

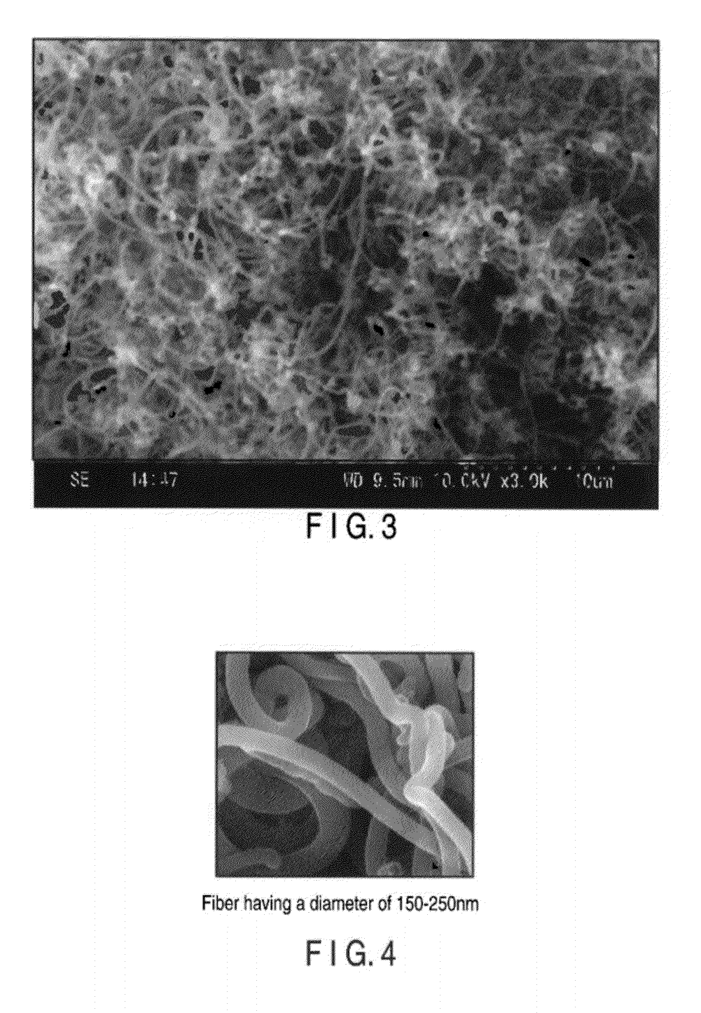

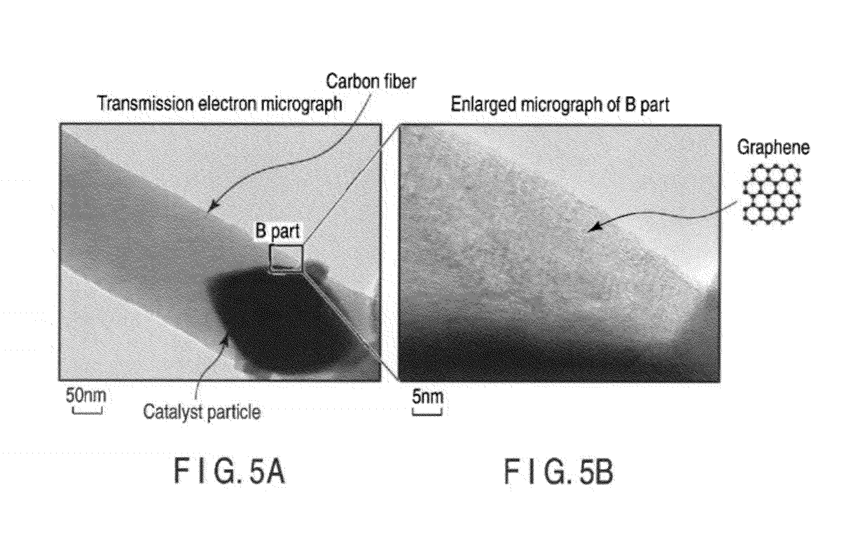

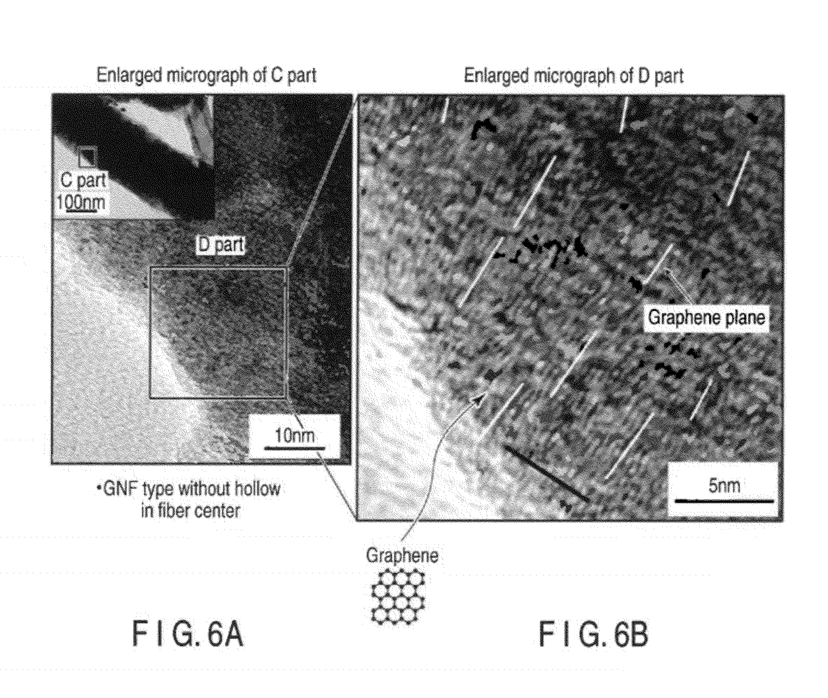

FIG. 3 is an electron microphotograph of fine carbon fibers. In FIG. 3, matters seen like twisted fibers are carbon fibers. FIG. 4 is an enlarged view of FIG. 3 and, specifically, an electron microphotograph of carbon fibers having a fiber diameter of from 100 to 300 nm. FIGS. 5A and 5B are transmission electron microphotographs of fine carbon fibers. It is found from FIG. 5A that carbon fibers are grown on both sides of the catalyst microparticle. Also, it is found from FIG. 5B that the fine carbon fiber has a structure in which crystallized graphene pieces are stacked. Moreover, FIGS. 6A and 6B are transmission microphotographs of fine carbon fibers and are carbon structures at a position slightly apart from the catalyst microparticles. FIG. 6A is a photograph of the enlarged part C enclosed by the square (□) on the upper left. In FIG. 6B which is a photograph of the enlarged part D, an approximate direction of graphene is indicated by the white line drawn on the photograph.

From the above fact, it was found that the fine carbon fibers produced by the apparatus of the embodiment were linear graphite nano-carbon fibers (GNF) which have a diameter of 100 to 300 nm and in which layers of graphenes were stacked in a longitudinal direction. Further analysis of the fine carbon fibers revealed that the distance between graphenes was 0.3 to 0.4 nm, these layers of graphenes were stacked to constitute a crystallite having an average crystal thickness of 3 to 10 nm and these crystellites are stacked, thereby constituting linear graphite nano-carbon fibers having a diameter of 100 to 300 nm.

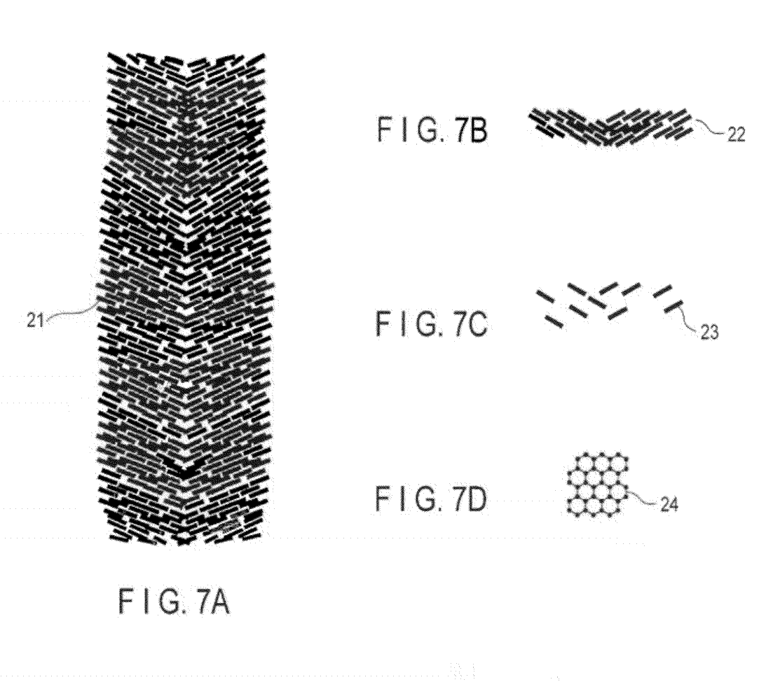

FIGS. 7A to 7D are views schematically illustrating the structure of the linear graphite nano-carbon fibers. FIG. 7A is a section of a graphite nano-carbon fiber 21 having an almost circular form, FIG. 7B is a section of a graphene block (crystallite) 22, FIG. 7C is a section of a graphene dispersed piece 23, and FIG. 7D shows a graphene 24.

The diameter of the fine carbon fiber was measured. Each distribution of the diameter of the measured four samples is shown in Table 1 below. Table 1 shows a diameter distribution with a primary diameter ranging from 100 to 300 nm. Also, Table 1 shows that the average diameter is 151.5 to 198.9 nm with a primary average diameter ranging from about 150 to 200 nm. The diameter including the data of other samples is 80 to 470 nm and preferably 130 to 300 nm.

The following Table 2 shows the results of measurements of specific surface area and bulk density. In the table, four samples are shown as examples. From Table 2, the specific surface area was 92.46 to 128.5 m²/g (gas adsorption BET method), and the specific surface area including the data of other samples is 70 to 130 m²/g and preferably 90 to 130 m²/g. The bulk density including the data of other samples is 0.1 to 0.35 g/cm³ and preferably 0.15 to 0.35 g/cm³.

TABLE 1

| | Sample 1 | Sample 2 | Sample 3 | Sample 4 |
|---|---|---|---|---|
| [nm] | (W100622-2) | (W100701-1) | (W100617-1) | (W100607-2) |
| 500~ | | | | |
| 475~650 | | | | |
| 450~600 | | | | |
| 425~450 | | | | |
| 400~425 | | | | |
| 375~400 | | | | |
| 350~375 | | | | |
| 325~350 | xx | | | x |
| 300~325 | x | | | |
| 275~300 | | x | | |
| 250~275 | xxxxx | x | | x |
| 225~250 | xxxxx | xxx | | xxxxxx |
| 200~225 | xxxxxx | xxxxx | xxxx | xxxxxxxx |
| 175~200 | xxxxxxxx | xxxxxxx | xxx | xxxxxxxxx |
| 150~175 | xx | xxxxxxxxxx | xxxxxxxxxxx | xxxxxxx |
| 125~150 | xxxx | xxxxxxxxxxx | xxxxxxxxxxxxxx | xxxxx |
| 100~125 | xxxxxxx | xx | xxxxxxx | xxx |
| 75~100 | | | x | |
| 50~75 | | | | |
| 25~50 | | | | |
| ~25 | | | | |
| Average | 198.9 | 175.6 | 151.5 | 191.6 |
| σ | 60.6 | 39.6 | 29.2 | 46.1 |
| Max | 328 | 288 | 220 | 347 |
| Min | 108 | 107 | 88 | 122 |

TABLE 2

| Measuring | Measuring | Sample | | | |
|---|---|---|---|---|---|
| items | method | 1 | Sample 2 | Sample 3 | Sample 4 |
| Specific | Gas | 98.4 | 128.5 | 100.7 | 92.46 |
| surface area | adsorption | | | | |
| (m²/g) | BET method | | | | |
| Bulk density | Volumetric | 0.16 | 0.22 | 0.34 | 0.16 |
| (g/cm³) | method | | | | |

[Specific surface area: BET method]
Glass volume: 5 mL
Amount of a sample: 2.5 mL
Deaerating temperature: 200° C.
Deaerating time: 30 min
Operating unit: trade name: HM model-1208, manufactured by Mountech Co., Ltd.
[Measurement of bulk density]
Volume of a measuring container: 25 mL
Tap height: 10 mm
Number of taps: 1000

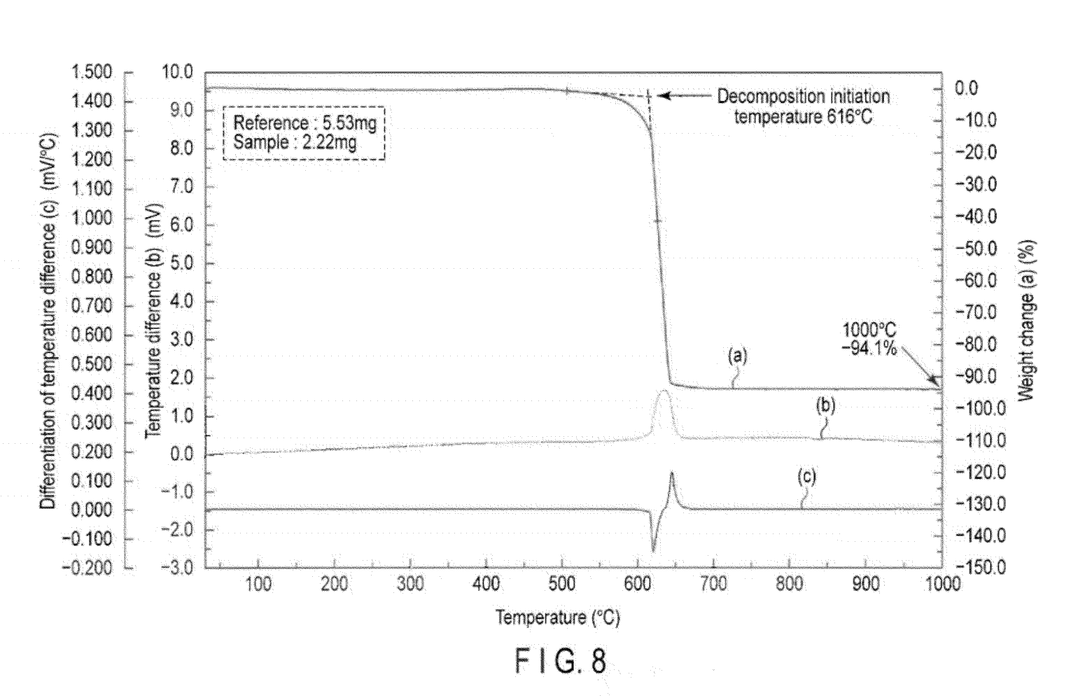

FIG. 8 is a characteristic diagram showing the relations between the temperature, and temperature difference, differentiation of the temperature difference (variation as a function of time) or variation in the weight of the fine carbon fibers obtained in the above embodiment. This diagram is based on the data in the temperature ranging up to 1000° C. In FIG. 8, (a) is a curve showing a variation in the weight of fine carbon fibers when the carbon fibers are heated, (b) is a curve showing a difference in the temperature (DTA) between a sample and a standard material when they are heated, and (c) is a curve showing a variation with time in temperature difference detected by a differential thermocouple. It is found from FIG. 8 that the decomposition initiation temperature (heat resistant temperature) is 616° C. and the ratio of weight reduction is 94.1% at 1000° C.

The results of four samples measured by this method are shown in the following Table 3. Table 3 shows the distribution of the decomposition initiation temperature (heat resistant temperature) ranging from 540° C. to 616° C. Also, the heat resistant temperature including the data of other samples is 530° C. to 630° C. and is preferably 540° C. to 620° C. Moreover, from Table 3, the rate of weight reduction (purity) is about 94% or more. Also, the rate of weight reduction including the data of other samples is 90 to 97% and is preferably 94 to 97%. The residues are components not combusted at 1000° C. and are assumed to be, for example, the catalyst.

TABLE 3

| | | | Rate of | |
|---|---|---|---|---|
| | | Decomposition | weight | |
| | | initiation | reduction | |
| | | temperature | at | |
| | | (Heat | temperature | |
| | | resistant | up to | |
| Sample | | temperature) | 1000° C. | Color of |
| name | Measurement | (° C.) | (%) | residues |
| Sample 1 | n = 1 | 612 | 95.4 | Reddish |
| | n = 2 | 616 | 94.1 | brown |
| Sample 2 | n = 1 | 546 | 94.8 | Reddish |
| | n = 2 | 540 | 94.9 | brown |
| Sample 3 | n = 1 | 544 | 96.3 | Reddish |
| | n = 2 | 542 | 96.1 | brown |
| Sample 4 | n = 1 | 602 | 95.8 | Reddish |
| | n = 2 | 598 | 96.7 | brown |

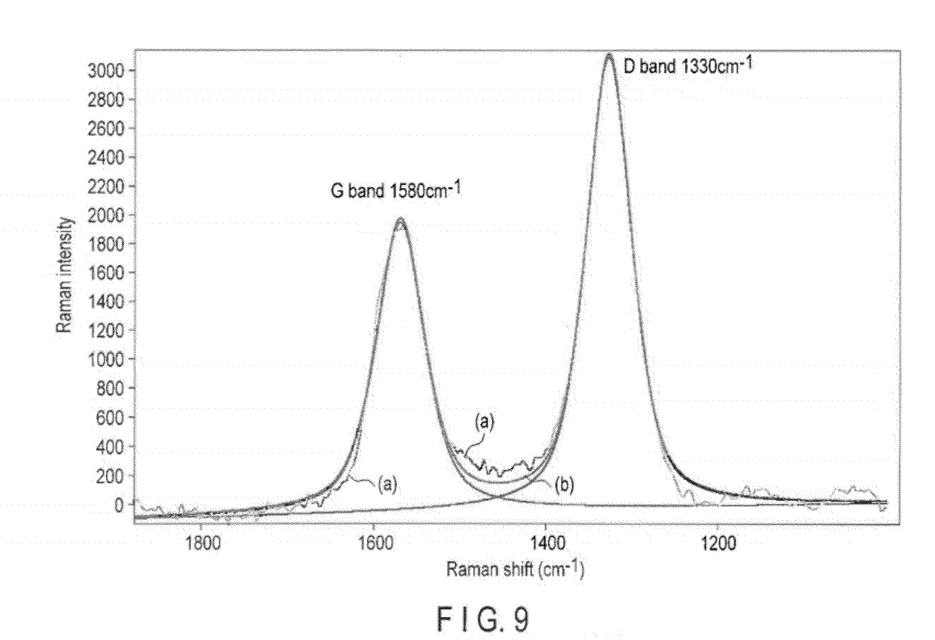

FIG. 9 shows the Raman spectrum of the fine carbon fibers. In FIG. 9, (a) is a curve showing the Raman spectrum, and (b) shows the result of fitting. It is clear from FIG. 9 that there appear a G-band (1580 cm⁻¹) of a graphite structure and a D-band (1330 cm⁻¹) derived from the defect of the graphite structure. The following Table 4 shows each Raman spectrum of four samples, IG/ID values of which are 0.64, 0.64, 0.55 and 0.60, respectively. At this time, IG and ID are heights of the X-axis center values of the G-band and D-band, respectively. Also, IG/ID values including the data of other samples are 0.5 to 0.8 and preferably 0.6 to 0.8.

TABLE 4

| Sample | | X-center | | Half value | | |
|---|---|---|---|---|---|---|
| name | Peak | value | Height | width | Area | IG/ID * |
| Sample 1 | D-band | 1328 | 3136 | 63 | 264426 | 0.64 |
| | G-band | 1570 | 2020 | 66 | 183380 | |
| Sample 2 | D-band | 1329 | 3089 | 63 | 250975 | 0.64 |
| | G-band | 1571 | 1979 | 66 | 162650 | |
| Sample 3 | D-band | 1340 | 2711 | 62 | 199023 | 0.55 |
| | G-band | 1584 | 1504 | 63 | 116774 | |
| Sample 4 | D-band | 1337 | 3041 | 65 | 251949 | 0.60 |
| | G-band | 1582 | 1812 | 67 | 147217 | |

* Ratio of peak heights of G-band and D-band
G-band: Crystalline carbon
D-band: Amorphous carbon including defects

In the production apparatus according to the above embodiment, carbon fibers are grown on the substrate and therefore, the catalyst metal is transferred to the carbon fiber to a minimal extent, so that the carbon fibers have very high purity. Also, the production apparatus enables continuous production and can therefore attain mass production, bringing about the possibility of industrial distribution.

Further, the carbon fibers produced in the above embodiment are expected to be dispersed with a smaller graphene shape due to its structure. The carbon fibers may be expected to be used in new applications such as electronic parts utilizing a high level of photoelectron mobility, chemical sensors and hydrogen storage materials utilizing chemical sensitivity and chemical reaction, mechanical sensors utilizing a high level of mechanical strength, laser parts and transparent electrodes utilizing light transmittance and electroconductivity and wiring materials utilizing high-current density resistance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A graphite nano-carbon fiber provided by using an apparatus comprising: a reactor capable of keeping a reducing atmosphere inside thereof, a metal substrate arranged as a catalyst in the reactor, a heater heating the metal substrate, a hydrocarbon source supplying hydrocarbon to the reactor, a scraper scraping carbon fibers produced on the metal substrate, a recovery container recovering the scraped carbon fibers, and an exhaust pump discharging exhaust gas from the reactor,
wherein the carbon fibers are linear carbon fibers with a diameter of 80 to 470 nm formed with layers of graphenes stacked in a longitudinal direction.

2. A graphite nano-carbon fiber provided by using an apparatus comprising: a cylindrical reactor capable of keeping a reducing atmosphere inside thereof, a cylindrical metal substrate arranged as a catalyst in the reactor coaxially with the reactor, a heater heating the metal substrate, a hydrocarbon source supplying hydrocarbons to the reactor, a scraper with a spiral scraping blade scraping carbon fibers produced on the inside wall of the metal substrate, a recovery container recovering the scraped carbon fibers, and an exhaust pump discharging exhaust gas from the reactor,
wherein the carbon fibers are linear carbon fibers with a diameter of 80 to 470 nm formed with layers of graphenes stacked in a longitudinal direction.

3. The graphite nano-carbon fiber according to claim 1, wherein the fiber has a specific surface area of 70 to 130 m²/g measured by a gas adsorption BET method.

4. The graphite nano-carbon fiber according to claim 1, wherein the fiber has a bulk density of 0.1 to 0.35 g/cm³.

5. The graphite nano-carbon fiber according to claim 1, wherein the fiber has a heat resistant temperature of 530 to 630° C.

6. The graphite nano-carbon fiber according to claim 1, wherein the fiber has a purity of 90 to 97%.

7. The graphite nano-carbon fiber according to claim 1, wherein IG/ID ranges 0.5 to 0.8, where IG represents crystalline carbon and ID represents amorphous carbon.

8. The graphite nano-carbon fiber according to claim 2, wherein the fiber has a specific surface area of 70 to 130 m²/g measured by a gas adsorption BET method.

9. The graphite nano-carbon fiber according to claim 2, wherein the fiber has a bulk density of 0.1 to 0.35 g/cm³.

10. The graphite nano-carbon fiber according to claim 2, wherein the fiber has a heat resistant temperature of 530 to 630° C.

11. The graphite nano-carbon fiber according to claim 2, wherein the fiber has a purity of 90 to 97%.

12. The graphite nano-carbon fiber according to claim 2, wherein IG/ID ranges 0.5 to 0.8, where IG represents crystalline carbon and ID represents amorphous carbon.

13. A method of producing a graphite nano-carbon fiber, comprising:
using an apparatus comprising a reactor capable of keeping a reducing atmosphere inside thereof, a metal substrate arranged as a catalyst in the reactor, a heater heating the metal substrate, a hydrocarbon source supplying hydrocarbon to the reactor, a scraper scraping carbon fibers produced on the metal substrate, a recovery container recovering the scraped carbon fibers, and an exhaust pump discharging exhaust gas from the reactor, to produce graphite nano-carbon fibers which are linear carbon fibers with a diameter of 80 to 470 nm formed with layers of graphenes stacked in a longitudinal direction.
